(19) United States
(12) Patent Application Publication
(10) Pub. No.: US 2007/0132142 A1
(43) Pub. Date: Jun. 14, 2007

(54) Vacuum infusion port apparatus and method of use

(75) Inventor: Ronald C. Voegeli, Oak Harbor, WA (US)

Correspondence Address: BUCHANAN, INGERSOLL & ROONEY PC, POST OFFICE BOX 1404, ALEXANDRIA, VA, 22313-1404, US

(73) Assignee: BAYVIEW EDISON INDUSTRIES, INC., MOUNT VERNON, WA (US)

(21) Appl. No.: 11/544,703

(22) Filed: Oct. 10, 2006

Related U.S. Application Data
(60) Provisional application No. 60/725,322, filed on Oct. 12, 2005.

(51) Int. Cl. B29C 70/44

(52) U.S. Cl. 264/258; 264/510; 264/571; 425/405.1; 425/DIG. 60

(57) ABSTRACT

Vacuum infusion molding is performed by inserting a flexible bag over dry goods disposed in an open mold space of a rigid mold, and over a plurality of bases disposed on the dry goods, attaching a periphery of the bag to the mold, making a slit in the bag over a through-passage of one of the bases, pushing a fitting through the slit and into the one base to communicate the mold space with an area outside of the mold space, and applying a vacuum to the mold space through that fitting to draw the bag tightly against a surface of the dry goods. Prior to the making of the slit, the bag is affixed to the one base without tearing the bag. During the subsequent application of the vacuum, the bag is unsecured relative to the other bases to be able to move freely relative to those other bases under the action of the vacuum.

The present invention claims priority under 35 U.S.C. §119 and/or §365 to U.S. Provisional Application Ser. No. 60/725,322 filed on Oct. 12, 2005.

### BACKGROUND OF THE INVENTION

The present invention relates to vacuum infusion molding and in particular to a reusable vacuum infusion port apparatus usable in such a molding process, and to its method of use in the process.

Vacuum infusion molding is a technique that uses vacuum pressure to drive resin into dry goods. Materials (dry goods) are laid dry into the mold, and the vacuum is achieved to cause resin to be forced into the dry goods. (See U.S. Pat. Nos. 5,601,852 and 7,048,985 for a description of a vacuum infusion process, which patents are incorporated by reference herein).

In a typical vacuum infusion molding technique, the “dry goods” 10 to be molded, e.g., fibers such as carbon fibers, fiberglass fibers, etc. are placed into a mold space of a rigid mold 11 (see FIG. 1). The mold space is open at its top to accommodate this placement. A number of blocks 12 (only one shown) are placed upon the dry goods, each block (formed e.g., of high density molecular polyethylene) having a through-passage 14 formed therein which includes a vertical upper section 16 that is open at its top. Preferably, a flow membrane (not shown) which is permeable to resin flow, is placed over the dry goods prior to placement of the blocks, so the blocks sit on the flow membrane. Next, a flexible bag or membrane 18 (shown as a single line in FIG. 1) is placed over the dry goods and over the blocks 12. A peripheral edge of the bag 18 is attached to a flange 19 of the mold by conventional tape (not shown). Slits are then formed in the bag directly over the upper section 16 of the respective through-passages, and a screw-threaded lower end of the conventional fittings 20 (formed e.g., of PVC) is pushed through respective slits and into a cylindrical (i.e., non-threaded) through-passage of a respective block. Tape (not shown) is then wrapped around the junction between each fitting and the upper end of the associated through-passage to seal the through-passage.

To preliminarily test for leaks, a vacuum is then applied at one or more of the fittings, the vacuum being transmitted to the mold space via the through passage(s) 14, causing the bag to be drawn tightly against the dry goods and the blocks. Also, the afore-mentioned tape tend to be drawn into the top of the through-hole to augment the sealing action. By monitoring the pressure in the mold space, the presence of leaks can be detected. Leakage detection is important because a certain minimum pressure, e.g., 26 pounds is needed to properly carry out the molding step.

The vacuum is continued to be held up until the molding step in order to keep the dry goods from shifting. That is especially important in cases where the mold is in an upright condition (i.e., the surface on which the blocks are seated is not horizontal).

The molding step is carried out by attaching at least one of the fittings 20 (termed resin fitting) to an open container of resin. A vacuum is again applied at another of the fittings (termed vacuum fitting). A pressure void is thus created within the mold space, enabling atmospheric pressure acting on the open resin container to push resin through the resin fitting(s), into the mold space, and through the dry goods. When the resin cures, the final product will comprise the dry goods and the plastic (hardened resin) entrained therein. Importantly, the bag should have been drawn tightly against the dry goods prior to the introduction of resin into the mold space to ensure that no voids were created between the bag and the dry goods where resin could accumulate and mar the appearance of the product being made.

The afore-described technique involves certain shortcomings. One shortcoming occurs after the bag has been slit and the fitting is being pushed therethrough into the respective block. Because at that time the bag is free to move relative to the block, the bag may be shifted as the fitting is inserted, possibly moving the slit past the upper end of the block's through-passage, thereby creating a leak risk at the fitting/block junction.

Another shortcoming results from the fact that it is undesirable in the prior art method to form a slit in the bag while the mold space is under a vacuum. That is because the vacuum will be stressing the bag, and the stressing can cause the slit to be undesirably enlarged to an excessive length. For that reason, the bag is slit and the fittings are attached to the blocks prior to the introduction of the vacuum. When a vacuum is initially applied to pull the bag tightly against the dry goods, the bag is physically moved and stretched. However, since the bag is attached to a plurality of spaced blocks, the movement of the bag will also displace the blocks, i.e., drag the blocks across the surface of the dry goods, thereby deforming the surface. Since that surface will shape the surface of the product being formed, there can result a poorly shaped product.

Another shortcoming exists because the securement of the bag to a plurality of blocks at the moment when the vacuum is applied will hinder the ability of the bag to be freely shifted/stretched into tight engagement with the entire surface of the dry goods, especially at the corners of the mold space. That can result in voids occurring between the that surface and the bag in which resin can accumulate to further mar the appearance of the product.

### SUMMARY OF A PREFERRED EMBODIMENT

A vacuum infusion port apparatus adapted for use in a vacuum infusion molding procedure, includes:

a base having a passage extending therethrough, the passage including a first seal structure;

a bushing including a hollow shaft portion configured to be received in the passage, the shaft having a second seal structure cooperable with the first seal structure to create a seal therewith; and

a fitting including an end portion configured to be received in a through-aperture of the bushing, the end portion including a third seal structure engageable with a fourth seal structure of the bushing to create a seal therewith.

In a method of vacuum infusion molding including inserting a flexible bag over dry goods disposed in an open mold space of a rigid mold, and over a base disposed on the dry goods, attaching a periphery of the bag to the mold, making a slit in the bag over a through-passage of the base, and pushing a fitting through the slit to communicate the mold space with an area outside of the mold space; the improvement comprising, prior to the making of the slit, affixing the bag to the base without tearing the bag, wherein during the subsequent slitting of the bag and the pushing of the fitting through the slit, the bag is held against sliding movement relative to the base.

In a method of vacuum infusion molding including inserting a flexible bag over dry goods disposed in an open mold space of a rigid mold, and over a plurality of bases disposed on the dry goods, attaching a periphery of the bag to the mold, making a slit in the bag over a through-passage of one of the bases, pushing a fitting through the slit and into the one base to communicate the mold space with an area outside of the mold space, and applying a vacuum to the mold space through that fitting to draw the bag tightly against a surface of the dry goods, the improvement comprising, prior to the making of the slit, affixing the bag to the one base without tearing the bag; and during the subsequent application of the vacuum, the bag is unsecured relative to the other bases to be able to move freely relative to those other bases under the action of the vacuum.

### BRIEF DESCRIPTION OF THE DRAWINGS

The objects and advantages of the invention will become apparent from the following detailed description of preferred embodiments thereof in connection with the accompanying drawings in which like numerals designate like elements.

FIG. 1 is an exploded, vertically sectioned side elevational view of a prior art vacuum infusion port apparatus, with a bag interposed between a base and a fitting of the apparatus.

FIG. 2 is a view similar to FIG. 1 of a preferred vacuum infusion port apparatus with a bag disposed between a base and a bushing of the apparatus.

FIG. 3 is a vertically sectioned side elevational view of a bushing of FIG. 2 mounted in the base of FIG. 2, with the bag sandwiched therebetween.

FIG. 4 is a vertically sectioned side elevational view of a bushing and a fitting of FIG. 2 mounted in the base of FIG. 2, with the bag sandwiched between the base and the bushing.

FIG. 5 is a schematic side elevational view of a plurality of bases resting on dry goods prior to the application of a vacuum, with a bag attached to one of the bases

FIG. 6 is a view similar to FIG. 5 after a fitting has been secured to one of the bases and a vacuum has been applied.

FIG. 7 is a top plan perspective view of the preferred vacuum infusion port apparatus.

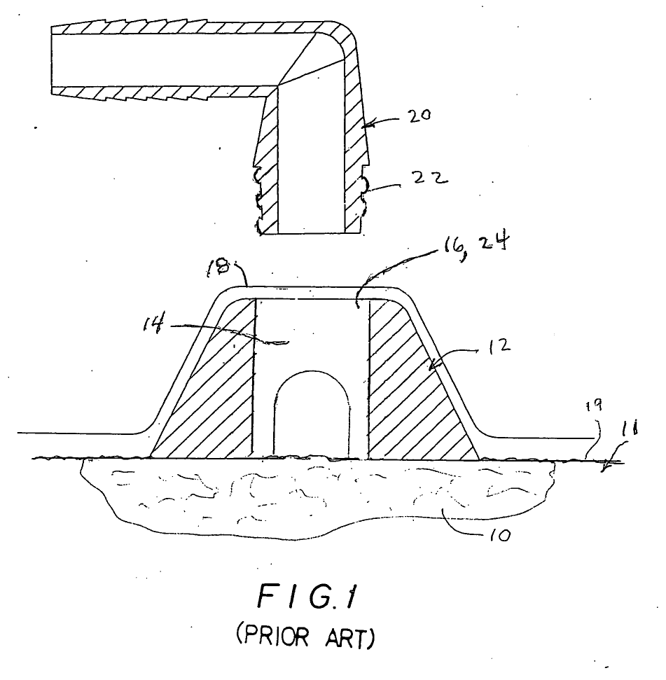

### DETAILED DESCRIPTION OF A PREFERRED EMBODIMENT

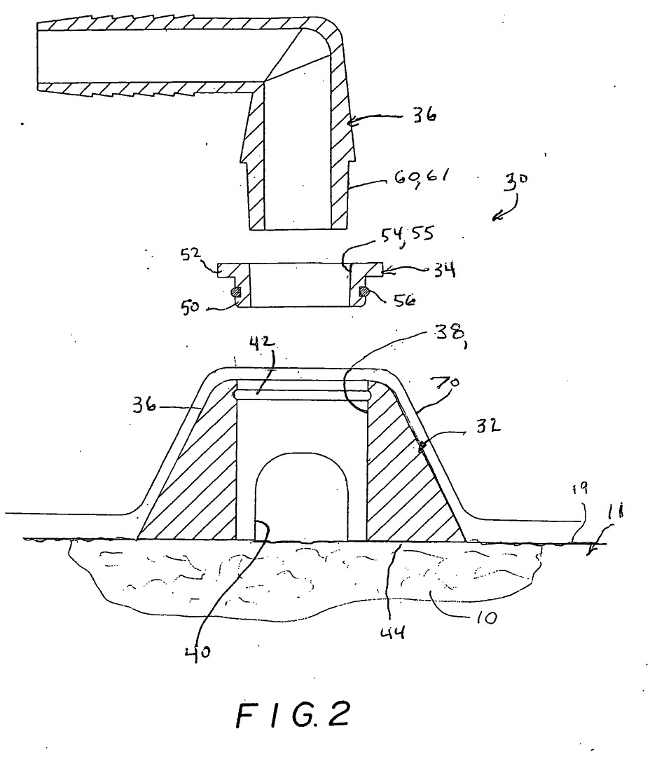

Depicted in FIG. 2 is a vacuum infusion port apparatus 30 which comprises a base (or block) 32, a bushing 34, and a fitting 36.

The base 32 is preferably formed of a material to which certain resins will not stick, such as ultra high molecular weight (UHMW) polyethylene. Formed in the base 32 is a through passage 36, the passage including a first section 38 and an optional lateral second section 40. Formed on the wall of the first section 38 is an annular groove 42. The base includes a flat bottom surface 44 adapted to rest on dry goods disposed in a vacuum infusion mold, as will be explained.

The bushing 34 can be formed of any suitable material, but preferably is formed of aluminum. The bushing includes a shaft 50 and a flange 52 disposed at one end of the shaft. The bushing is hollow in that a through-aperture 54 is formed therein by a wall 55 which is tapered in a direction away from the flange, i.e., the wall is of frusto-conical shape. Disposed on an outer surface of the shaft 50 is an annular groove in which a seal in the form of an elastic O-ring 56 is disposed. The shaft 50 is configured to be inserted into the first section 38 of the through-passage of the base, and the O-ring 56 is adapted to snap into the groove 42 of the base 32 to form a seal and hold the bushing in the through-passage, as will be explained.

The fitting 36 is hollow and formed of any suitable material, preferably plastic such as PVC, and includes an end section 60 which is tapered in complementary fashion to the taper of the bushing's through-aperture 54 i.e., the end section 60 is of frusto-conical shape. That shape can be created by machining-off the screw threads of the conventional fitting 20. When the fitting is inserted into the bushing, a tight seal is formed between the outer surface 61 of the vertical section 60 and the wall 55 of the through aperture 54.

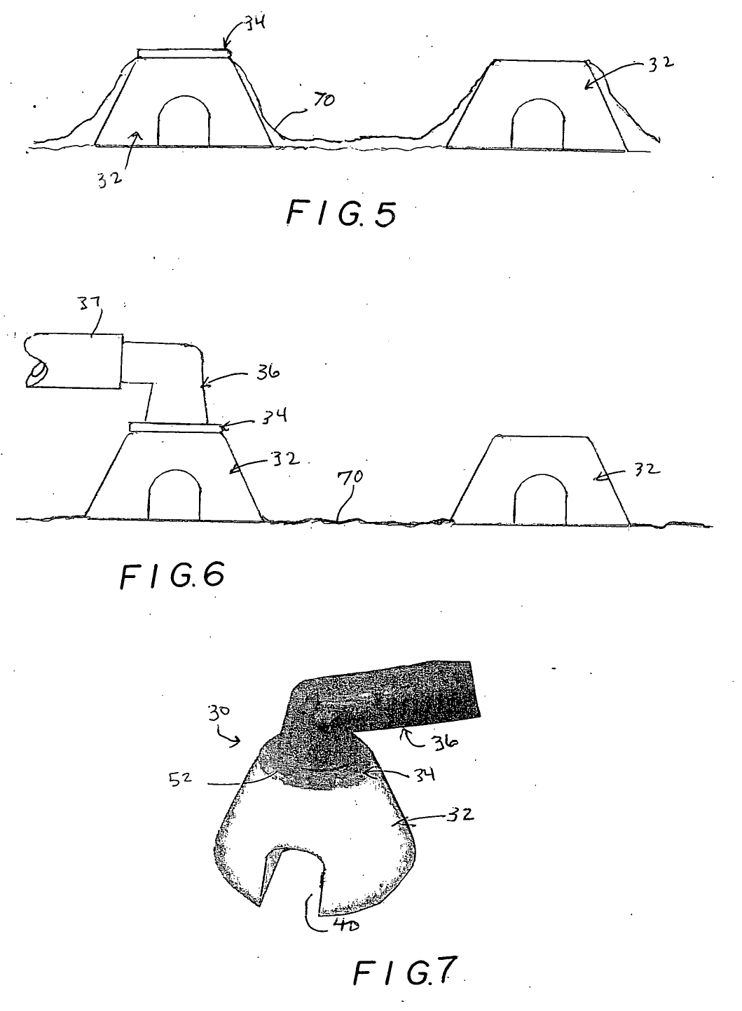

As explained earlier, in a vacuum infusion molding process, dry goods (e.g., various fibers) are inserted into a mold space of a rigid mold 11. The mold space is open, e.g., open at its top if the mold is horizontal, to accommodate such placement. Preferably, the dry goods are covered by a conventional flow membrane (not shown), the flow membrane being permeable to liquid resin being used in the process. A number of the bases 32 (see FIG. 5) are placed upon the dry goods, (i.e., on the flow membrane), and can be held by a releasable glue if desired, especially if the mold is not horizontal. A flexible bag or membrane 70 (e.g., formed of nylon film or other film) is then placed over the bases 32 and over the dry goods. The bag can be formed of any suitable flexible, stretchable material, such as nylon film. A peripheral edge of the bag is sealed to a flange 19 of the mold 11 in a conventional way, e.g., by tape, in order to create a seal around the mold space. It is important that there be no appreciable leakage so that a suitably high vacuum can be established in the mold space during the molding step.

It is necessary to insert the fitting 36 through the bag and into the base in order to provide a conduit through which a vacuum can be introduced into the mold space (e.g., to perform a lead test or a molding operation). This is done after forming a slit in the bag over the through-passage 36. Conventionally, a potential problem was encountered in that the bag could tend to shift relative to the base as the fitting was inserted, which could lead to leaks through the slit, as explained earlier.

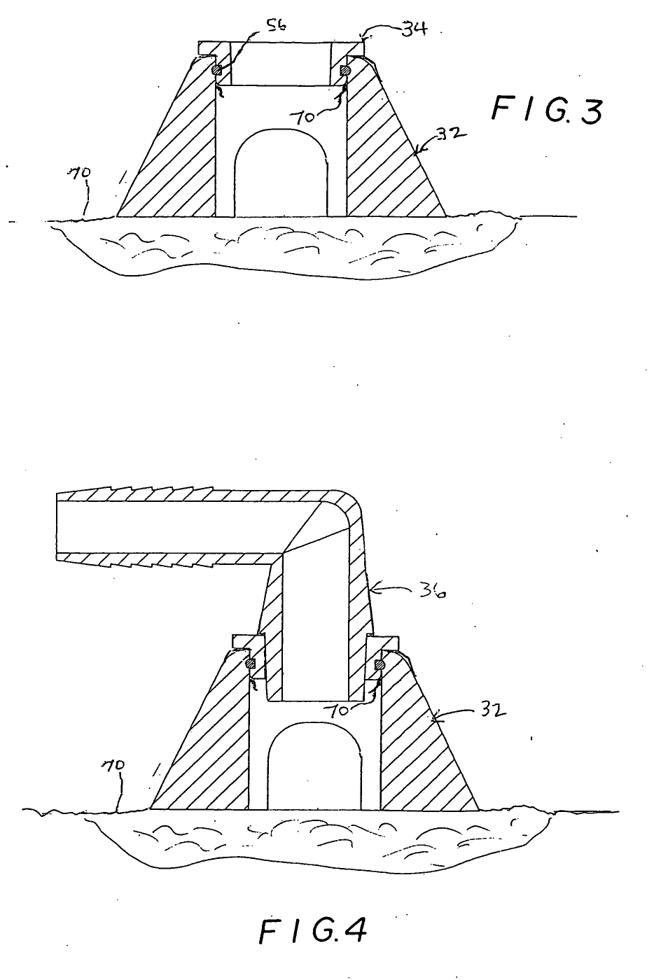

That problem is avoided by the use of the bushing 34 which, prior to the bag-slitting step, is inserted into the through-passage of one of the bases 32 from outside of the bag 70 (i.e., against an outer face of the bag) until the O-ring 56 snaps into the groove 42 (see FIG. 3). Thus, a portion of the bag that overlies the through-passage is forced into the first section 38 of the through passage and becomes tightly sandwiched between the O-ring 56 and the groove 42, with the upper end of that section 38 being covered by part of the bag. This is accomplished without tearing the bag. Next, a slit of any suitable shape is formed in that part of the bag overlying the first section 38, e.g., manually with a knife, and the end section 60 of the fitting is pushed through the slit and into the through-aperture of the bushing (see FIG. 4).

A tight fit of the fitting in the bushing automatically results from the complementary tapering of the mutually engaging frusto-conical surfaces 61,55 of the fitting and the bushing, in contrast to conventional methods in which a screw-threaded end of the fitting is pushed into a cylindrical through-passage of the block. That has necessitated in the application of tape around the fitting at the junction with the through-passage to create a seal. That can be very time-consuming, especially in cases where large numbers of bases, e.g., 70-80, are employed. In the present embodiment, those conventional screw-threads are machined-off in a manner creating the frusto-conical surface.

During the insertion of the fitting into the bushing, the part of the bag 70 overlying the respective base 32 is held against movement by the bushing. Thus, the bag cannot shift relative to the base, so the slit cannot become shifted to a location extending beyond the diameter of the through-passage of the base which, if it were to occur, could result in leakage. Such leakage could require a new set-up of a bag, or if not detected, could result in a failed molding process.

It will also be appreciated that a tight seal is created between mutually co-operating seal structures defined by the O-ring 56 and the groove 42 on the one hand, and by the mutually facing surfaces 61 and 55 of the fitting and the bushing's through-aperture on the other hand.

In order to perform a leak test, a conduit 37 is attached to the fitting 36 and to a suitable vacuum pump which applies a vacuum that is transmitted to the mold space via the vacuum infusion port apparatus 30 (see FIG. 6). This results in the bag 70 being pulled tightly against the dry goods, i.e., tightly against the flow membrane. By monitoring the pressure in the mold space, the presence of leaks around the periphery of the bag can be detected.

Importantly, the bag 70 is not attached to any of the other bases 32 during the application of the vacuum, as is apparent from FIGS. 5 and 6. Thus, when the bag is displaced into tight engagement with the dry goods by the vacuum, the bag is free to slide across those other bases, and thus will not drag them across the surface of the dry goods as would occur if the bag had been attached to those other bases as in conventional methods. Accordingly, the surface of the dry goods does not become deformed. Also, the ability of the bag to slide in that manner enables the bag to more precisely conform to the shape of the surface of the dry goods, especially at the corners of the mold space.

Assuming that no leaks are detected, the vacuum is maintained in the mold space to hold the bag and dry goods in place (which is especially important if the mold is not horizontally oriented or is even upside-down). Then, a vacuum infusion molding procedure can be performed by inserting bushings and fittings into the remaining ones of the bases in the same manner as described above. One or more additional ones of the fittings (vacuum fittings) can be secured to a vacuum pump, and one or more of the fittings (resin fittings) can be connected to a source of liquid resin, preferably to an open container of resin. Then, a vacuum is applied at the vacuum fittings and is transmitted to the mold space to create a pressure void therein which enables atmospheric pressure to act on the resin in the open resin container and push the resin through the respective resin fitting(s) and into the mold space and through the dry goods. After the resin cures, the product comprising the dry goods and the plastic (i.e., the cured resin impregnated therein), is removed from the mold.

It will be appreciated that the use of the bushing 34 to secure the bag 70 to the respective base prior to forming the slit in the bag ensures that the bag and its slit cannot be shifted relative to the base to any appreciable extent when the fitting is installed in the base, so the risk of leakage through the slit is minimized.

In addition, by having the bag secured to only one of the bases when the vacuum is initially applied, the bag is free to slide relative to the other bases to be able to contact the entire surface of the dry goods, even at the corners of the mold space. Also, the bag will not displace the other bases as it slides relative thereto and thus will not displace those bases in a manner which could deform the surface of the dry goods.

The base 32, the bushing 34 and the fitting 36 are reusable since the resin will not stick to the materials of the base and the fitting, and since the wall 55 of the bushing is covered by the bag after the fitting has been inserted, so contact between the bushing and the resin is essentially prevented.

What is claimed is:

1. A vacuum infusion port apparatus adapted for use in a vacuum infusion molding procedure, comprising:
a base having a passage extending therethrough, the passage including a first seal structure;
a bushing including a hollow shaft portion configured to be received in the passage, the shaft having a second seal structure cooperable with the first seal structure to create a seal therewith; and
a fitting including an end portion configured to be received in a through-aperture of the bushing, the end portion including a third seal structure engageable with a fourth seal structure of the bushing to create a seal therewith.

2. The vacuum infusion port apparatus according to claim 1 wherein the first seal structure comprises an annular groove; and the second sealing structure comprises an elastic O-ring receivable in the groove.

3. A vacuum infusion port apparatus adapted for use in a vacuum infusion molding procedure, comprising:
a base formed of ultra high molecular weight polyethylene and having a passage extending therethrough, the passage including an annular groove formed therein;
a bushing formed of aluminum and including a hollow shaft portion configured to be received in the passage, the shaft carrying an elastic O-ring on an exterior surface thereof, the O-ring configured to be receiving in the groove to form a seal therewith; and
a plastic fitting including an end portion configured to be received in a through-aperture of the hollow bushing, the fitting including a seal structure cooperable with a seal structure of the through-aperture to form a seal therewith.

4. The vacuum infusion port apparatus according to claim 3, wherein the seal structures of the fitting and the through-aperture comprise complementarily tapered frusto-conical surfaces.

5. In a method of vacuum infusion molding comprising inserting a flexible bag over dry goods disposed in an open mold space of a rigid mold, and over a base disposed on the dry goods, attaching a periphery of the bag to the mold, making a slit in the bag over a through-passage of the base, and pushing a fitting through the slit to communicate the mold space with an area outside of the mold space; the improvement comprising, prior to the making of the slit, affixing the bag to the base without tearing the bag, wherein during the subsequent slitting of the bag and the pushing of the fitting through the slit, the bag is held against sliding movement relative to the base.

6. In the method according to claim 5, wherein the affixing step is performed by pushing a bushing against an outer face of the bag to cause the bag to become sandwiched and sealed between the bushing and the base.

7. In the method according to claim 6, wherein the pushing of the bushing is performed to cause a shaft of the bushing to enter the through-passage, wherein the bag becomes sandwiched between an outer surface of the shaft and a wall of the through passage.

8. In the method according to claim 7 wherein the shaft is pushed into the through-passage until first and second sealing structures disposed respectively on the block and the bushing cooperate with one another to sandwich the bag therebetween.

9. In the method according to claim 8 wherein the first sealing structure comprises an annular groove formed in a wall of the through-passage, and the second sealing structure comprises an elastic O-ring disposed on an outer surface of the shaft and received in the groove, wherein the bag is sandwiched between the O-ring and the groove.

10. In the method according to claim 5 wherein an outer surface of the fitting is of frusto-conical shape and engages a complementarily shaped frusto-conical wall of the through-aperture.

11. In a method of vacuum infusion molding comprising inserting a flexible bag over dry goods disposed in an open mold space of a rigid mold, and over a plurality of bases disposed on the dry goods, attaching a periphery of the bag to the mold, making a slit in the bag over a through-passage of one of the bases, pushing a fitting through the slit and into the one base to communicate the mold space with an area outside of the mold space, and applying a vacuum to the mold space through that fitting to draw the bag tightly against a surface of the dry goods, the improvement comprising, prior to the making of the slit, affixing the bag to the one base without tearing the bag; and during the subsequent application of the vacuum, the bag is unsecured relative to the other bases to be able to move freely relative to those other bases under the action of the vacuum.
